(19) United States
(12) Patent Application Publication
(10) Pub. No.: US 2026/0229170 A1
(43) Pub. Date: Aug. 6, 2026

(54) DISPLAY PANEL, DRIVING METHOD THEREOF, AND DISPLAY APPARATUS

(71) Applicant: Wuhan Tianma Microelectronics Co., Ltd., Wuhan (CN)

(72) Inventor: Di ZHANG, Wuhan (CN)

(73) Assignee: Wuhan Tianma Microelectronics Co., Ltd., Wuhan (CN)

(21) Appl. No.: 19/631,033

(22) Filed: Mar. 27, 2026

(30) Foreign Application Priority Data
Oct. 17, 2025 (CN) 202511492610.2

(51) Int. Cl. G09G 3/32; G09G 3/3233

(52) U.S. Cl. CPC G09G 3/32; G09G 3/3233; G09G 2300/043; G09G 2300/0819; G09G 2310/0286; G09G 2310/08; G09G 2320/0247

(57) ABSTRACT

Provided are a display panel, a driving method thereof, and a display apparatus. The display panel includes sub-pixels, wherein the sub-pixels include a pixel circuit and a light-emitting device that are electrically connected to each other, an i-th row of sub-pixels includes a plurality of sub-pixels arranged along a first direction, a plurality of rows of sub-pixels are arranged along a second direction, and the second direction intersects the first direction, wherein i is a positive integer; and one operating period of the pixel circuit includes a reset phase, a data writing phase, and a light-emitting phase, and during the reset phase and/or the data writing phase of an (i+1)-th row of sub-pixels, the i-th row of sub-pixels is in the light-emitting phase, and an (i+2)-th row of sub-pixels is in the light-emitting phase.

### CROSS-REFERENCE TO RELATED APPLICATION

The present application claims priority to Chinese Patent Application No. 202511492610.2, filed on Oct. 17, 2025, the content of which is incorporated herein by reference in its entirety.

### TECHNICAL FIELD

The present application relates to the field of display technologies, and in particular, to a display panel, a driving method thereof, and a display apparatus.

### BACKGROUND

With the development of display technologies, consumers have increasingly high requirements for the performance of display panels, especially for their eye protection. However, in the prior art, when a display panel displays a frame of picture, brightness fluctuations in the frame of picture are relatively obvious, which is detrimental to human eye protection. Therefore, there is an urgent need for a solution.

### SUMMARY

In view of this, embodiments of the present application provide a display panel, a driving method thereof, and a display apparatus to solve the aforementioned problem.

In a first aspect, an embodiment of the present application provides a display panel, including a plurality of sub-pixels, where the sub-pixels include a pixel circuit and a light-emitting device that are electrically connected to each other, an i-th row of sub-pixels includes a plurality of sub-pixels arranged along a first direction, a plurality of rows of sub-pixels are arranged along a second direction, and the second direction intersects the first direction, where i is a positive integer;
one operating period of the pixel circuit includes a reset phase, a data writing phase, and a light-emitting phase, and during the reset phase and/or the data writing phase of an (i+1)-th row of sub-pixels, the i-th row of sub-pixels is in the light-emitting phase, and an (i+2)-th row of sub-pixels is in the light-emitting phase.

In a second aspect, based on the same inventive concept, an embodiment of the present application provides a driving method of a display panel, where the display panel includes a plurality of sub-pixels, an i-th row of sub-pixels includes a plurality of sub-pixels arranged along a first direction, a plurality of rows of sub-pixels are arranged along a second direction, the second direction intersects the first direction, and i is a positive integer; and the method includes:
in one frame of picture of the display panel, during a period when an (i+1)-th row of sub-pixels does not emit light, driving the i-th row of sub-pixels to emit light and driving an (i+2)-th row of sub-pixels to emit light.

In a third aspect, based on the same inventive concept, an embodiment of the present application provides a display apparatus, including the display panel as provided in the first aspect.

In the embodiments of the present application, during the reset phase and/or the data writing phase of the (i+1)-th row of sub-pixels, the i-th row of sub-pixels is set to be in the light-emitting phase t3, and the (i+2)-th row of sub-pixels is set to be in the light-emitting phase t3. Thus, during at least part of the period when the (i+1)-th row of sub-pixels is in the dark state, the two rows of sub-pixels adjacent to it and located on opposite sides thereof can be in the light-emitting state, thereby being conducive to preventing the multiple rows of sub-pixels in a same area from being dimmed simultaneously, reducing the obviousness of the dark state of the (i+1)-th row of sub-pixels, and weakening the light-dark difference perceived by human eyes, thereby reducing the damage to human eyes caused by the picture, and realizing the eye protection function of the display panel.

### BRIEF DESCRIPTION OF DRAWINGS

In order to more clearly illustrate the technical solutions of the embodiments of the present application, the accompanying drawings required in the embodiments will be briefly described below. Apparently, the accompanying drawings in the description below are only some embodiments of the present application. For a person of ordinary skill in the art, other accompanying drawings can also be obtained based on these drawings without creative efforts.

FIG. 1 is a schematic diagram of a display panel according to an embodiment of the present application;

FIG. 2 is a schematic diagram of a pixel circuit in FIG. 1;

FIG. 3 is a timing diagram of the pixel circuit shown in FIG. 2;

FIG. 4 is a driving timing diagram of a display panel according to an embodiment of the present application;

FIG. 5 is a driving timing diagram of a display panel according to the related art;

FIG. 6 is a schematic diagram of light and dark of a displayed picture in the related art;

FIG. 7 is a schematic diagram of light and dark of a displayed picture according to an embodiment of the present application;

FIG. 8 is a driving timing diagram of another display panel according to an embodiment of the present application;

FIG. 9 is a schematic diagram of a driving sequence of a display panel according to an embodiment of the present application;

FIG. 10 is a schematic diagram of a driving sequence of another display panel according to an embodiment of the present application;

FIG. 11 is a timing diagram of driving groups in FIG. 10;

FIG. 12 is a driving timing diagram of another display panel according to an embodiment of the present application;

FIG. 13 is a schematic diagram of another display panel according to an embodiment of the present application;

FIG. 14 is a cascade sequence diagram of shift register units in FIG. 13;

FIG. 15 is a schematic diagram of a display apparatus according to an embodiment of the present application.

### DESCRIPTION OF EMBODIMENTS

In order to better understand the technical solutions of the present application, the embodiments of the present application are described in detail below with reference to the accompanying drawings.

It should be clear that the described embodiments are only some rather than all of the embodiments of the present application. All other embodiments obtained by a person of ordinary skill in the art without creative efforts on the basis of the embodiments of the present application fall within the protection scope of the present application.

The terms used in the embodiments of the present application are only for the purpose of describing specific embodiments, and are not intended to limit the present application. The singular forms “a/an”, “said”, and “the” used in the embodiments of the present application and the appended claims are also intended to include plural forms, unless the context clearly indicates otherwise.

It should be understood that the term “and/or” used herein is merely an association relationship describing associated objects, indicating that three relationships may exist; for example, A and/or B may indicate the three cases: A exists alone, both A and B exist, and B exists alone. In addition, the character “/” herein generally indicates that the associated objects before and after it are in an “or” relationship.

Without departing from the spirit or scope of the present application, various modifications and changes can be made in the present application, which is apparent to a person of ordinary skill in the art. Therefore, the present application intends to cover the modifications and changes of the present application that fall within the scope of (the technical solutions claimed in) the corresponding claims and their equivalents. It should be noted that the implementation provided in the embodiments of the present application can be combined with each other where there is no contradiction.

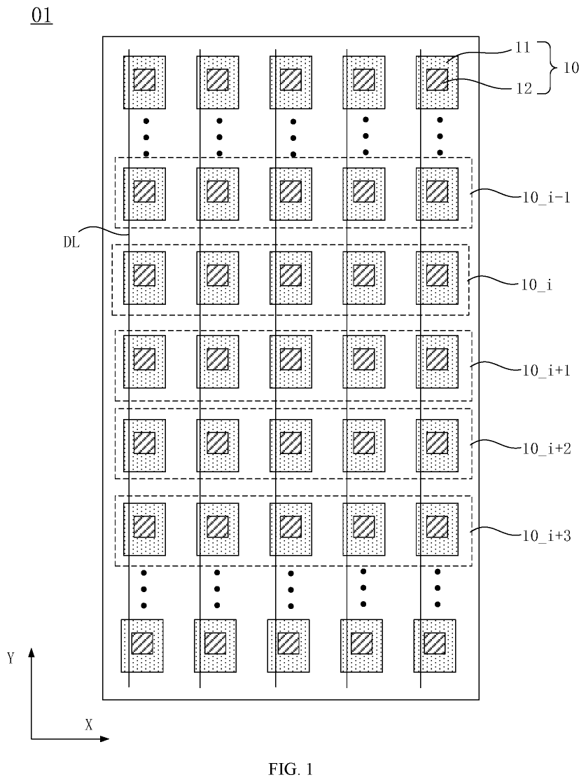

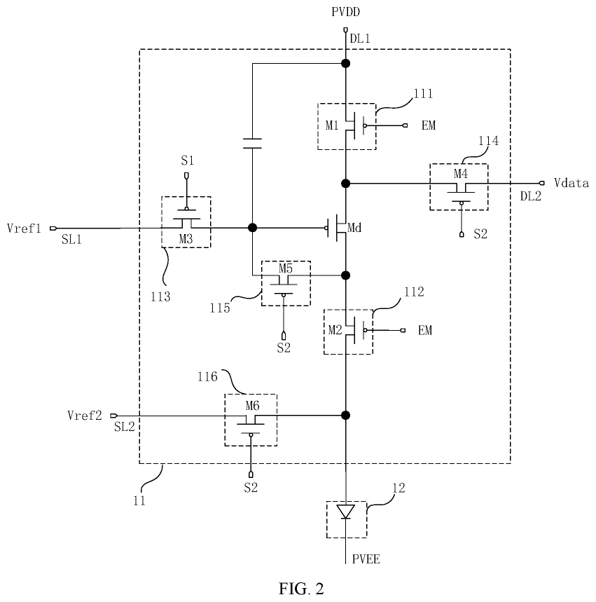

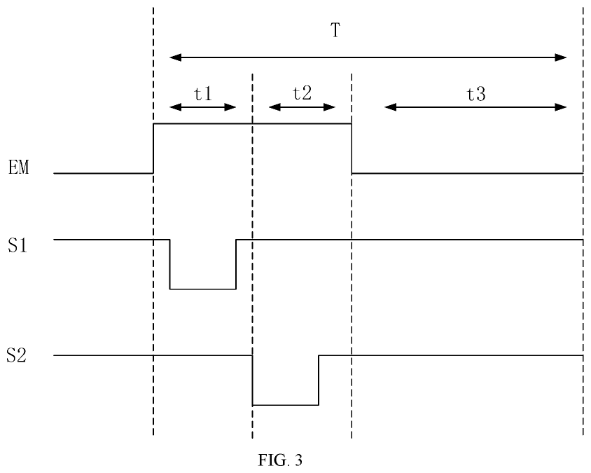

FIG. 1 is a schematic diagram of a display panel according to an embodiment of the present application, FIG. 2 is a schematic diagram of a pixel circuit in FIG. 1, and FIG. 3 is a timing diagram of the pixel circuit shown in FIG. 2.

An embodiment of the present application provides a display panel 01, as shown in FIG. 1. The display panel 01 includes a plurality of sub-pixels 10, the sub-pixels 10 include a pixel circuit 11 and a light-emitting device 12 that are electrically connected to each other, and the pixel circuit 11 is configured to drive the light-emitting device 12 to emit light. The light-emitting device 12 may be an organic light-emitting diode (OLED), a mini light-emitting diode (mini-LED), or a micro light-emitting diode (micro-LED), which is not specifically limited in the present application.

An i-th row of sub-pixels 10_i includes a plurality of sub-pixels 10 arranged along a first direction X, a plurality of rows of sub-pixels 10 are arranged along a second direction Y, and the second direction Y intersects the first direction X, where i is a positive integer.

That is to say, the plurality of sub-pixels 10 arranged along the first direction X may form a row of sub-pixels, which, of course, may also be referred to as a sub-pixel row, and the plurality of sub-pixel rows are arranged along the second direction Y.

Exemplarily, the first direction X is the row direction of the display panel 01, and the second direction Y is the column direction of the display panel 01.

With reference to FIGS. 2 and 3, one operating period T of the pixel circuit 11 includes a reset phase t1, a data writing phase t2, and a light-emitting phase t3, the data writing phase t2 is subsequent to the reset phase t1, and the light-emitting phase t3 is subsequent to the data writing phase t2. During the reset phase t1 and the data writing phase t2, the light-emitting device 12 does not emit light, that is, the sub-pixel 10 does not emit light. During the light-emitting phase t3, the light-emitting device 12 emits light, that is, the sub-pixel 10 emits light.

In a same row of sub-pixels 10, operating states of the pixel circuits 11 may be the same. That is, the pixel circuits 11 in one row of sub-pixels 10 may all be in the reset phase t1, or all be in the data writing phase t2, or all be in the light-emitting phase t3.

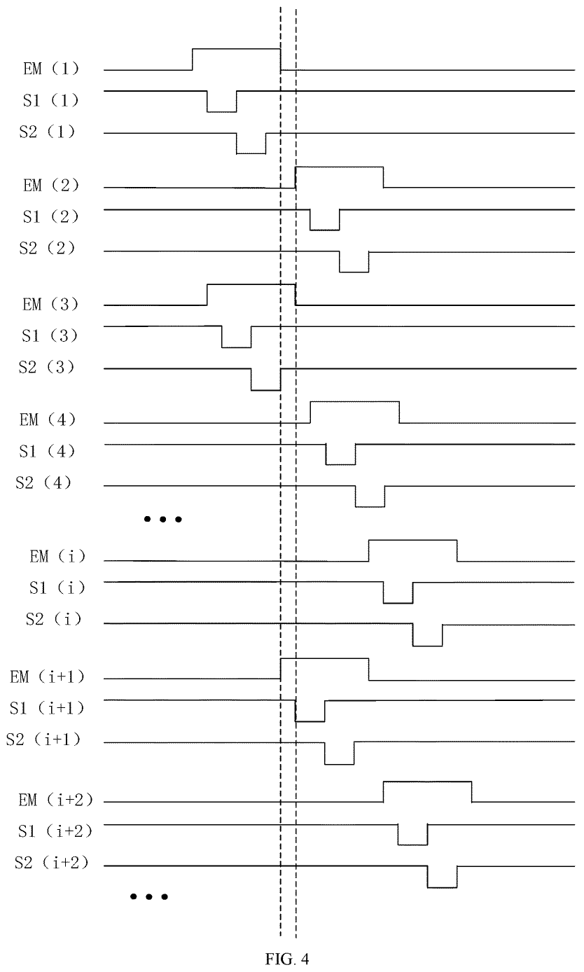

Herein, with reference to FIGS. 3 and 4, FIG. 4 is a driving timing diagram of a display panel according to an embodiment of the present application, during the reset phase t1 and/or the data writing phase t2 of an (i+1)-th row of sub-pixels 10_i+1, an i-th row of sub-pixels 10_i is in the light-emitting phase t3, and an (i+2)-th row of sub-pixels 10_i+2 is in the light-emitting phase t3.

That is to say, in one frame of picture of the display panel 01, during at least part of a period when the (i+1)-th row of sub-pixels 10_i+1 do not emit light, both the i-th row of sub-pixels 10_i (the previous row of sub-pixels of the (i+1)-th row of sub-pixels 10_i+1) and the (i+2)-th row of sub-pixels 10_i+2 (the next row of sub-pixels of the (i+1)-th row of sub-pixels 10_i+1) are emitting light.

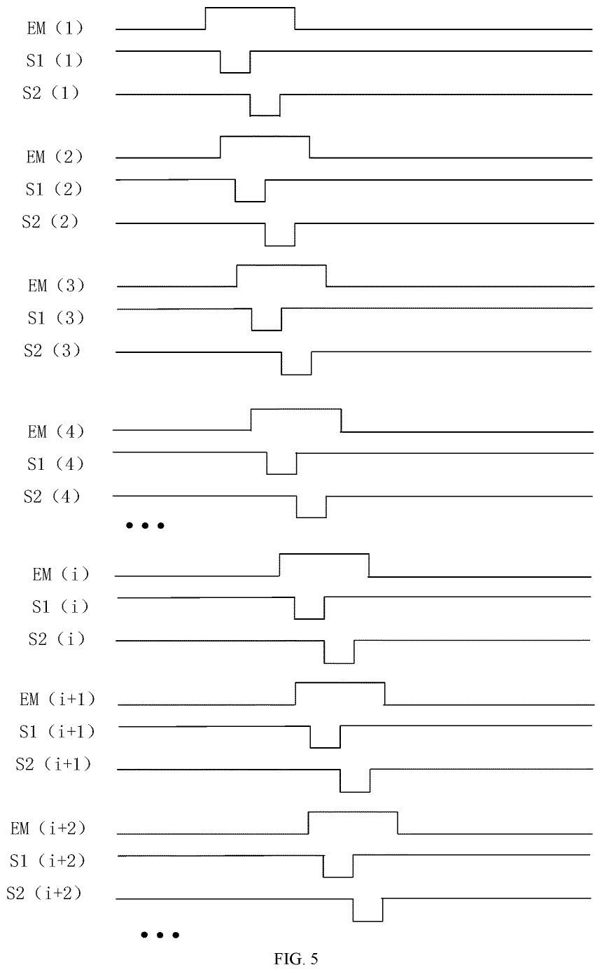

The inventor of the present application has found through research that, as shown in FIG. 5, FIG. 5 is a driving timing diagram of a display panel in the related art. In the related art, during the process of displaying one frame of picture by the display panel 01, the rows of sub-pixels 10 are usually driven successively in the order of arrangement along the second direction Y. For example, with reference to FIGS. 1, 2, 3, and 5, the first row of sub-pixels, the second row of sub-pixels, . . . , the i-th row of sub-pixels 10_i, the (i+1)-th row of sub-pixels 10_i+1, and the (i+2)-th row of sub-pixels 10_i+2 enter the reset phase t1, the data writing phase t2, and the light-emitting phase t3 successively. When one row of sub-pixels starts to execute the data writing phase t2, the next row of sub-pixels thereof is still executing the reset phase t1.

Based on this driving manner, with reference to FIGS. 3 and 5, it can be seen that at any moment when the (i+1)-th row of sub-pixels 10_i+1 is in the reset phase t1 and the data writing phase t2, at least one of the i-th row of sub-pixels 10_i and the (i+2)-th row of sub-pixels 10_i+2 is not in the light-emitting phase t3. For example, as shown in FIG. 5, when the (i+1)-th row of sub-pixels 10_i+1 is at the start time of the data writing phase t2, the i-th row of sub-pixels 10_i is in the data writing phase t2, and the (i+2)-th row of sub-pixels 10_i+2 is in the reset phase t1.

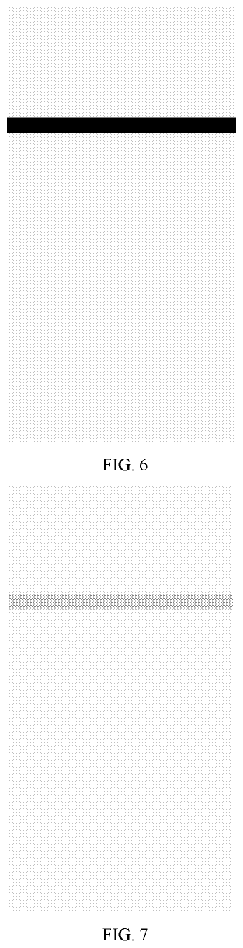

This causes the several adjacent rows of sub-pixels in a same area to be dimmed simultaneously within one frame of picture. As shown in FIG. 6, FIG. 6 is a schematic diagram of light and dark of a displayed picture in the related art. When a high-speed camera (with a shutter speed<1/8000 s) is used to capture the picture, obvious black stripes can be observed in the displayed picture, where the black stripes indicate the dark state of the sub-pixel rows. This thus results in obvious light-dark fluctuations within one frame, which is not conducive to human eye protection.

In the embodiment of the present application, during the reset phase t1 and/or the data writing phase t2 of the (i+1)-th row of sub-pixels 10_i+1, the i-th row of sub-pixels 10_i is set to be in the light-emitting phase t3, and the (i+2)-th row of sub-pixels 10_i+2 is set to be in the light-emitting phase t3. Thus, during at least part of the period when the (i+1)-th row of sub-pixels 10_i+1 is in the dark state, the two rows of sub-pixels adjacent to it and located on opposite sides thereof can be in the light-emitting state, thereby being conducive to preventing the multiple rows of sub-pixels in the same area from being dimmed simultaneously, reducing the obviousness of the dark state of the (i+1)-th row of sub-pixels 10_i+1, and weakening the light-dark difference perceived by human eyes, thereby reducing the damage to human eyes caused by the picture, and realizing the eye protection function of the display panel.

Exemplarily, as shown in FIG. 7, FIG. 7 is a schematic diagram of light and dark of a displayed picture according to the embodiment of the present application. When a high-speed camera (with a shutter speed<1/8000 s) is used to capture the picture, it can be seen that the color of the black stripes in FIG. 7 is significantly lighter than the color of the black stripes in FIG. 6. The embodiment of the present application can effectively improve the flicker within a frame of picture and enhance the human eye protection function.

It should be noted that, in some other embodiments, one operating period of the pixel circuit 11 may further include other phases, such as a bias adjustment phase. As long as the pixel circuit 11 is not in the light-emitting phase t3, the sub-pixel 10 is in the dark state. In the embodiment of the present application, at any moment when the (i+1)-th row of sub-pixels 10_i+1 is in the dark state, the two rows of sub-pixels 10 adjacent to it and located on opposite sides thereof can be set to be in the light-emitting phase t3, so as to greatly reduce the flicker degree within a frame of picture and further improve the human eye protection function of the display panel.

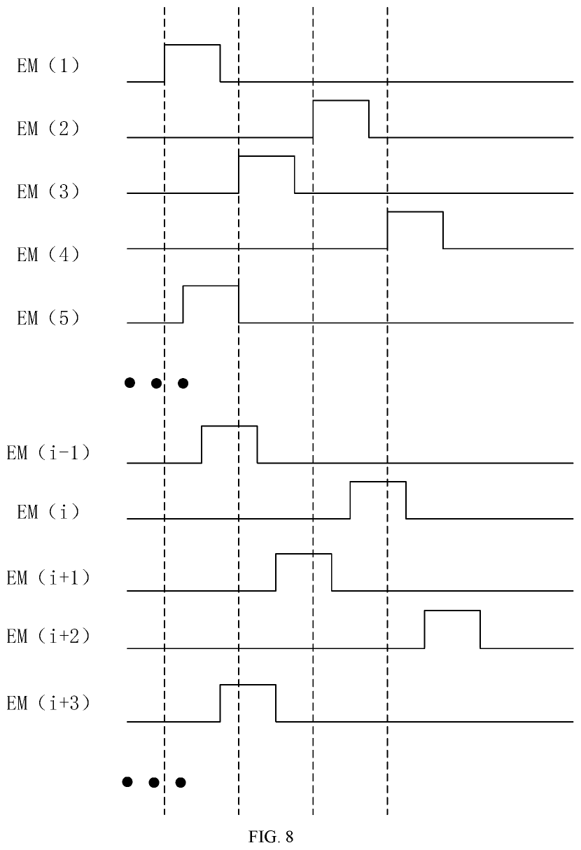

FIG. 8 is a driving timing diagram of another display panel according to an embodiment of the present application.

In one embodiment of the present application, with reference to FIGS. 1, 2, 3, and 8, during the reset phase t1 and/or the data writing phase t2 of the (i+1)-th row of sub-pixels 10_i+1, the at least two rows of sub-pixels adjacent to the (i+1)-th row of sub-pixels 10_i+1 and located on one side of the (i+1)-th row of sub-pixels 10_i+1 are in the light-emitting phase t3, and the at least two rows of sub-pixels adjacent to the (i+1)-th row of sub-pixels 10_i+1 and located on the other side of the (i+1)-th row of sub-pixels 10_i+1 are in the light-emitting phase t3.

That is to say, during the reset phase t1 and/or the data writing phase t2 of the (i+1)-th row of sub-pixels 10_i+1, at least the i-th row of sub-pixels 10_i and the (i-1)-th row of sub-pixels 10_i−1 are in the light-emitting phase t3, and at least the (i+2)-th row of sub-pixels 10_i+2 and the (i+3)-th row of sub-pixels 10_i+3 are in the light-emitting phase t3. In this embodiment, i≥2.

In the embodiment of the present application, during the reset phase t1 and/or the data writing phase t2 of the (i+1)-th row of sub-pixels 10_i+1, the at least two rows of sub-pixels adjacent to the (i+1)-th row of sub-pixels 10_i+1 and located on one side of the (i+1)-th row of sub-pixels 10_i+1 are set to be in the light-emitting phase t3, and the at least two rows of sub-pixels adjacent to the (i+1)-th row of sub-pixels 10_i+1 and located on the other side of the (i+1)-th row of sub-pixels 10_i+1 are set to be in the light-emitting phase t3, such that during at least part of the period when the (i+1)-th row of sub-pixels 10_i+1 is in the dark state, at least the “previous” two rows of sub-pixels and at least the “subsequent” two rows of sub-pixels relative to the (i+1)-th row of sub-pixels 10_i+1 are both in the light-emitting state, which is conducive to further reducing the obviousness of the dark state of the (i+1)-th row of sub-pixels 10_i+1, thereby further weakening the light-dark difference perceived by human eyes and improving the human eye protection function of the display panel 01.

To facilitate understanding of the technical solutions of the present application, the structure and operating process of the pixel circuit shown in FIG. 2 are briefly described below with reference to FIGS. 2 and 3.

As shown in FIG. 2, the pixel circuit 11 includes a driving transistor Md, a power voltage writing module 111, and a light-emitting control module 112. The power voltage writing module 111 has an input terminal electrically connected to a first power voltage signal line DL1, an output terminal electrically connected to a first electrode of the driving transistor Md, and a control terminal electrically connected to a light-emitting control signal line EM. The power voltage writing module 111 is configured to transmit a first power voltage PVDD transmitted by the first power voltage signal line DL1 to the first electrode of the driving transistor Md.

The light-emitting control module 112 has an input terminal electrically connected to a second electrode of the driving transistor Md, an output terminal electrically connected to a first electrode of the light-emitting device 12, and a control terminal electrically connected to the light-emitting control signal line EM. A signal transmitted by the light-emitting control signal line EM controls the power voltage writing module 111 and the light-emitting control module 112 to be in a same switching state. A second electrode of the light-emitting device 12 may receive a second power voltage PVEE.

Herein, the first electrode of the light-emitting device 12 may be an anode thereof, and the second electrode of the light-emitting device 12 may be a cathode thereof.

During the light-emitting phase t3, the light-emitting control signal line EM transmits an enable signal, and both the power voltage writing module 111 and the light-emitting control module 112 are in a turned-on state.

During the reset phase t1 and the data writing phase t2, the light-emitting control signal line EM transmits a disable signal, and both the power voltage writing module 111 and the light-emitting control module 112 are in a turned-off state.

Exemplarily, as shown in FIG. 2, the power voltage writing module 111 includes a first transistor M1. The first transistor M1 has a first electrode electrically connected to the first power voltage signal line DL1, a second electrode electrically connected to the first electrode of the driving transistor Md, and a gate electrically connected to the light-emitting control signal line EM.

The light-emitting control module 112 includes a second transistor M2. The second transistor M2 has a first electrode electrically connected to the second electrode of the driving transistor Md, a second electrode electrically connected to the first electrode of the light-emitting device 12, and a gate electrically connected to the light-emitting control signal line EM.

With reference to FIG. 3, during the light-emitting phase t3, the light-emitting control signal line EM transmits an enable signal (e.g., a low-level signal), the first transistor M1 and the second transistor M2 are turned on, and the pixel circuit 11 transmits a driving current to the light-emitting device 12 to drive the light-emitting device 12 to emit light. That is to say, the sub-pixel 10 emits light.

During the reset phase t1 and the data writing phase t2, the light-emitting control signal line EM transmits a disable signal (e.g., a high-level signal), the first transistor M1 and the second transistor M2 are turned off, the pixel circuit 11 stops providing the driving current to the light-emitting device 12, and the light-emitting device 12 does not emit light. That is to say, the sub-pixel 10 does not emit light and is in a dark state.

It should be noted that a same sub-pixel row may be connected to a same light-emitting control signal line EM. In the timing diagrams shown in FIGS. 4 and 8, during the period when the light-emitting control signal line EM connected to a sub-pixel row transmits a disable signal (e.g., a high-level signal), the row of sub-pixels does not emit light and is in a dark state.

Further, as shown in FIG. 2, the pixel circuit 11 further includes a first reset module 113, a data writing module 114, a threshold capturing module 115, and a second reset module 116. The first reset module 113 has an input terminal electrically connected to a first reset voltage signal line SL1, an output terminal electrically connected to a gate of the driving transistor Md, and a control terminal electrically connected to a first scan line S1. The first reset module 113 is configured to transmit a first reset voltage Vref1 on the first reset voltage signal line SL1 to the gate of the driving transistor Md to reset the gate of the driving transistor Md.

The data writing module 114 has an input terminal electrically connected to a data signal line DL2, an output terminal electrically connected to the first electrode of the driving transistor Md, and a control terminal electrically connected to a second scan line S2. The data writing module 114 is configured to transmit a data voltage Vdata on the data signal line DL2 to the first electrode of the driving transistor Md.

The threshold capturing module 115 has an input terminal electrically connected to the second electrode of the driving transistor Md, an output terminal electrically connected to the gate of the driving transistor Md, and a control terminal electrically connected to the second scan line S2. The threshold capturing module 115 is configured to compensate a threshold voltage of the driving transistor Md to the gate of the driving transistor Md.

The second reset module 116 has an input terminal electrically connected to a second reset voltage signal line SL2, an output terminal electrically connected to the first electrode of the light-emitting device 12, and a control terminal electrically connected to the second scan line S2. The second reset module 116 is configured to transmit a second reset voltage Vref2 on the second reset voltage signal line SL2 to the first electrode of the light-emitting device 12 to reset the first electrode of the light-emitting device 12.

In one operating period of the pixel circuit 11, the data writing phase t2 is subsequent to the reset phase t1, and the light-emitting phase t3 is subsequent to the data writing phase t2.

Herein, the first reset module 113 is turned on during the reset phase t1, and the second reset module 116, the data writing module 114, and the threshold capturing module 115 are turned on during the data writing phase t2.

Exemplarily, as shown in FIG. 2, the first reset module 113 includes a third transistor M3. The third transistor M3 has a first electrode electrically connected to the first reset voltage signal line SL1, a second electrode electrically connected to the gate of the driving transistor Md, and a gate electrically connected to the first scan line S1. The data writing module 114 includes a fourth transistor M4. The fourth transistor M4 has a first electrode electrically connected to the data signal line DL2, a second electrode electrically connected to the first electrode of the driving transistor Md, and a gate electrically connected to the second scan line S2.

The threshold capturing module 115 includes a fifth transistor M5. The fifth transistor M5 has a first electrode electrically connected to the second electrode of the driving transistor Md, a second electrode electrically connected to the gate of the driving transistor Md, and a gate electrically connected to the second scan line S2. The second reset module 116 includes a sixth transistor M6. The sixth transistor M6 has a first electrode electrically connected to the second reset voltage signal line SL2, a second electrode electrically connected to the first electrode of the light-emitting device 12, and a gate electrically connected to the second scan line S2.

Herein, a same sub-pixel row is connected to a same first scan line S1 and a same second scan line S2. The sub-pixels in a same row may enter the reset phase t1 and the data writing phase t2 simultaneously.

With reference to FIG. 3, during the reset phase t1, the first scan line S1 transmits an enable signal (e.g., a low-level signal), the third transistor M3 is turned on, and the first reset voltage Vref1 is transmitted to the gate of the driving transistor Md through the turned-on third transistor M3, completing the reset of the gate of the driving transistor Md.

During the data writing phase t2, the first scan line S1 transmits a disable signal (e.g., a high-level signal), and the second scan line S2 transmits an enable signal (e.g., a low-level signal). The third transistor M3 is turned off, while the fourth transistor M4, the fifth transistor M5, and the sixth transistor M6 are turned on. The data voltage Vdata is transmitted to the first electrode of the driving transistor Md through the turned-on fourth transistor M4. At this time, since the potential of the gate of the driving transistor Md is Vref1, the driving transistor Md is turned on, and the data voltage Vdata is transmitted to the gate of the driving transistor Md through the turned-on driving transistor Md and the fifth transistor M5 until the potential of the gate of the driving transistor Md reaches Vdata-|Vth|, and the driving transistor Md is turned off, where Vth is the threshold voltage of the driving transistor Md.

Meanwhile, the second reset voltage Vref2 is transmitted to the first electrode of the light-emitting device 12 through the turned-on sixth transistor M6, completing the reset of the first electrode of the light-emitting device 12.

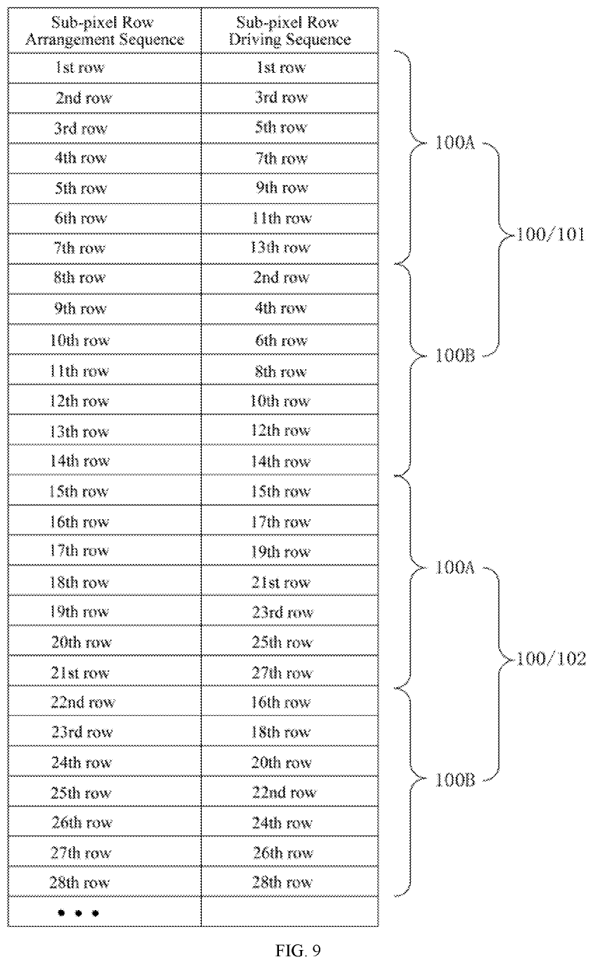

FIG. 9 is a schematic diagram of a driving sequence of a display panel according to an embodiment of the present application.

In one embodiment of the present application, as shown in FIG. 9, a plurality of sub-pixel rows in the display panel 01 form at least one driving group 100. A same driving group 100 includes a first group of sub-pixel rows 100A and a second group of sub-pixel rows 100B. During one frame of picture of the display panel 01, the first group of sub-pixel rows 100A and the second group of sub-pixel rows 100B are driven sequentially.

Herein, a plurality of rows of sub-pixels in the first group of sub-pixel rows 100A and a plurality of rows of sub-pixels in the second group of sub-pixel rows 100B are alternately arranged along the second direction Y.

That is to say, during one frame of picture of the display panel 01, the rows of sub-pixels 10 in the first group of sub-pixel rows 100A in one driving group 100 may enter the operating process sequentially first, and then the rows of sub-pixels 10 in the second group of sub-pixel rows 100B in the driving group 100 enter the operating process sequentially. In the second direction Y, the sub-pixel rows belonging to the first group of sub-pixel rows 100A and the sub-pixel rows belonging to the second group of sub-pixel rows 100B in the driving group 100 are alternately arranged.

In the embodiment of the present application, by configuring the first group of sub-pixel rows 100A and the second group of sub-pixel rows 100B in the same driving group 100 to be driven sequentially, and the sub-pixel rows in the first group of sub-pixel rows 100A to be alternately arranged with the sub-pixel rows in the second group of sub-pixel rows 100B, interleaved driving of the plurality of sub-pixel rows in the same driving group 100 can be achieved, which is conducive to driving the i-th row of sub-pixels 10_i and the (i+2)-th row of sub-pixels 10_i+2 to enter the light-emitting phase t3 sequentially, and then driving the (i+1)-th row of sub-pixels 10_i+1 to enter the reset phase t1 or the data writing phase t2, thereby being conducive to achieving that when the (i+1)-th row of sub-pixels 10_i+1 is in the dark state, the two rows of sub-pixels adjacent to the (i+1)-th row of sub-pixels 10_i+1 and located on opposite sides of the (i+1)-th row of sub-pixels 10_i+1 can be in the light-emitting state, and in turn conducive to reducing the obviousness of the dark state of the (i+1)-th row of sub-pixels 10_i+1.

Exemplarily, as shown in FIG. 9, in the same driving group 100, the number of the sub-pixel rows included in the first group of sub-pixel rows 100A is the same as the number of the sub-pixel rows included in the second group of sub-pixel rows 100B.

Herein, the plurality of rows of sub-pixels in the first group of sub-pixel rows 100A are odd-numbered rows of sub-pixels, and the plurality of rows of sub-pixels in the second group of sub-pixel rows 100B are even-numbered rows of sub-pixels.

For example, as shown in FIG. 9, in the display panel 01, 14 rows of sub-pixels sequentially arranged along the second direction Y form one driving group 100, where 7 odd-numbered rows of sub-pixels 10 belong to the first group of sub-pixel rows 100A, and 7 even-numbered rows of sub-pixels 10 belong to the second group of sub-pixel rows 100B. During the display of one frame of picture, after the odd-numbered rows of sub-pixels 10 in the driving group 100 enter the operating process sequentially, the even-numbered rows of sub-pixels 10 enter the operating process sequentially.

Configuring the odd-numbered rows of sub-pixels in the driving group 100 to form the first group of sub-pixel rows 100A and the even-numbered rows of sub-pixels to form the second group of sub-pixel rows 100B is conducive to reducing the grouping complexity of the sub-pixel rows in the driving group 100 and improving the distribution regularity of the first group of sub-pixel rows 100A and the second group of sub-pixel rows 100B, thereby being conducive to reducing the complexity of interleaved driving of the sub-pixel rows in the driving group 100.

With continued reference to FIG. 9, in one embodiment of the present application, the display panel 01 includes a plurality of driving groups 100, and the plurality of driving groups 100 are driven sequentially.

Exemplarily, as shown in FIG. 9, the plurality of driving groups 100 include a first driving group 101, a second driving group 102, and the like. During the display of one frame of picture by the display panel 01, the first driving group 101, the second driving group 102 ... are driven sequentially.

Since the number of the sub-pixel rows in the display panel 01 is relatively large, in the embodiment of the present application, configuring the display panel 01 to include a plurality of driving groups 100 is conducive to preventing the number of the sub-pixel rows in each driving group 100 from being excessively large, being conducive to reducing the driving difficulty of the display panel 01 and avoiding simultaneous dimming of a plurality of sub-pixel rows adjacently arranged.

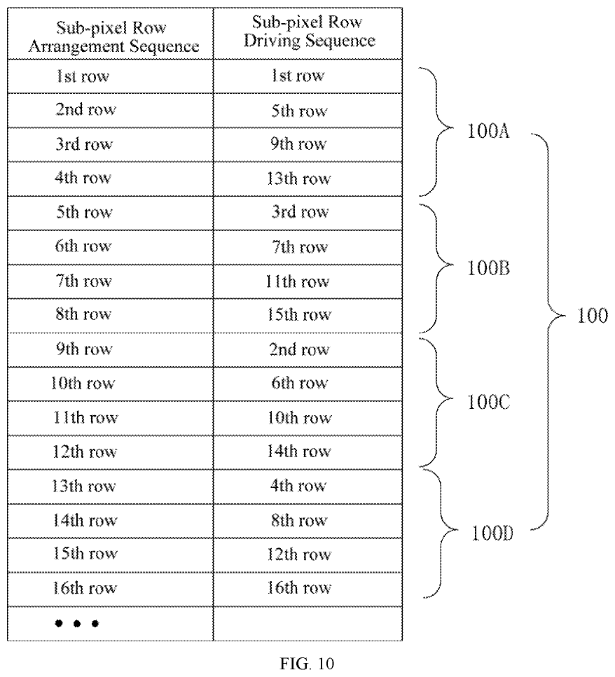

FIG. 10 is a schematic diagram of a driving sequence of another display panel according to an embodiment of the present application.

In one embodiment of the present application, with reference to FIGS. 1 and 10, in the same group of sub-pixel rows, there are at least two rows of sub-pixels not belonging to the group between any two adjacent rows of sub-pixels in the second direction Y.

For example, as shown in FIGS. 10, 16 rows of sub-pixels arranged along the second direction Y form one driving group 100. A same driving group 100 includes a first group of sub-pixel rows 100A, a second group of sub-pixel rows 100B, a third group of sub-pixel rows 100C, and a fourth group of sub-pixel rows 100D. In the same driving group 100, the first group of sub-pixel rows 100A includes a 1st row of sub-pixels, a 5th row of sub-pixels, a 9th row of sub-pixels, and a 13th row of sub-pixels; a second group of sub-pixel rows 100B includes a 3rd row of sub-pixels, a 7th row of sub-pixels, an 11th row of sub-pixels, and a 15th row of sub-pixels; the third group of sub-pixel rows 100C includes a 2nd row of sub-pixels, a 6th row of sub-pixels, a 10th row of sub-pixels, and a 14th row of sub-pixels; and the fourth group of sub-pixel rows 100D includes a 4th row of sub-pixels, an 8th row of sub-pixels, a 12th row of sub-pixels, and a 16th row of sub-pixels.

With reference to FIGS. 1 and 10, it can be seen that there are three rows of sub-pixels not belonging to the first group of sub-pixel rows 100A between any two adjacent rows of sub-pixels in the first group of sub-pixel rows 100A. For instance, between the 1st row of sub-pixels and the 5th row of sub-pixels in the first group of sub-pixel rows 100A, there are the 2nd row of sub-pixels, the 3rd row of sub-pixels, and the 4th row of sub-pixels, all of which do not belong to the first group of sub-pixel rows 100A. Similarly, there are three rows of sub-pixels not belonging to the second group of sub-pixel rows 100B between any two adjacent rows of sub-pixels in the second group of sub-pixel rows 100B; there are three rows of sub-pixels not belonging to the third group of sub-pixel rows 100C between any two adjacent rows of sub-pixels in the third group of sub-pixel rows 100C; and there are three rows of sub-pixels not belonging to the fourth group of sub-pixel rows 100D between any two adjacent rows of sub-pixels in the fourth group of sub-pixel rows 100D.

In the embodiment of the present application, by configuring that there are at least two rows of sub-pixels not belonging to the same group of sub-pixel rows between any two adjacent rows of sub-pixels in the group, it is possible to drive the sub-pixel rows between the two adjacent rows of sub-pixels in the same group of sub-pixel rows to enter the reset phase t1 after sequentially driving the two adjacent rows of sub-pixels in the group to enter the light-emitting phase t3, which is conducive to achieving that when one sub-pixel row in the group is in the dark state, at least two rows of sub-pixels adjacent to the one sub-pixel row and located on one side of the one sub-pixel row are in the light-emitting state, and at least two rows of sub-pixels adjacent to the one sub-pixel row and located on the other side of the one sub-pixel row are also in the light-emitting state, thereby further weakening the visual effect of the dark state sub-pixel row.

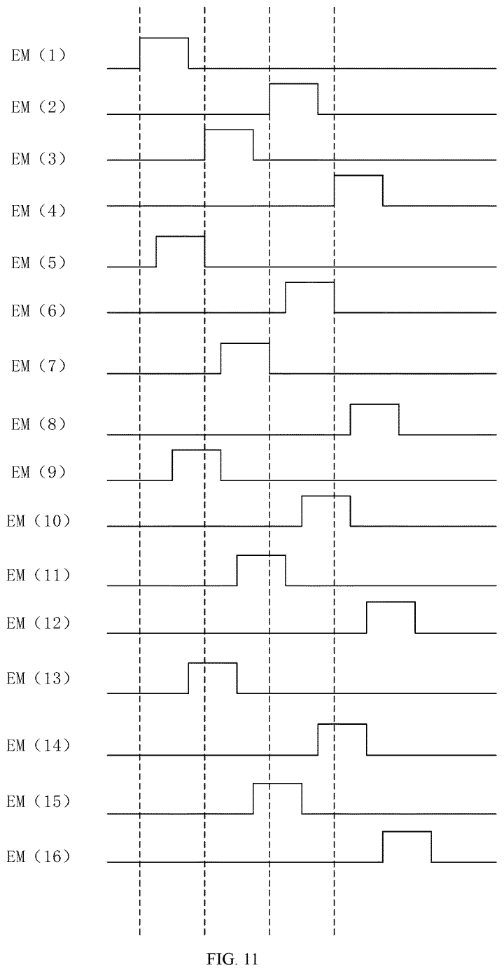

Exemplarily, with reference to FIGS. 10 and 11, FIG. 11 is a timing diagram of driving groups in FIG. 10. In a same driving group 100, the first group of sub-pixel rows 100A, the second group of sub-pixel rows 100B, the third group of sub-pixel rows 100C, and the fourth group of sub-pixel rows 100D are driven sequentially. It can be seen that when one row of sub-pixels in the first group of sub-pixel rows 100A is in the dark state (EM is a high-level signal), the “previous” three rows of sub-pixels and the “subsequent” three rows of sub-pixels of this row of sub-pixels (excluding the 1st row of sub-pixels) are both in the light-emitting state.

For example, when the 5th row of sub-pixels in the first group of sub-pixel rows 100A is in the dark state, the 2nd row of sub-pixels, the 3rd row of sub-pixels, and the 4th row of sub-pixels located on one side thereof are in the light-emitting state (EM is a low-level signal), and the 6th row of sub-pixels, the 7th row of sub-pixels, and the 8th row of sub-pixels located on the other side thereof are also in the light-emitting state.

In one embodiment of the present application, with reference to FIGS. 4 and 9, both the first group of sub-pixel rows 100A and the second group of sub-pixel rows 100B in the same driving group 100 include n rows of sub-pixels.

In one frame of picture of the display panel 01, in the same group of sub-pixel rows, the periods during which the light-emitting control signal lines EM of m rows of sub-pixels transmit disable signals (e.g., high-level signals) overlap.

Herein, n>m, and both n and m are positive integers.

Exemplarily, with reference to FIGS. 4 and 9, i in FIG. 4 may be 12. It can be reasonably inferred from FIGS. 4 and 9 that the first group of sub-pixel rows 100A includes 7 rows of sub-pixels, where the periods during which the light-emitting control signal lines EM of the 1st row of sub-pixels, the 3rd row of sub-pixels, the 5th row of sub-pixels, the 7th row of sub-pixels, the 9th row of sub-pixels, and the 11th row of sub-pixels transmit disable signals (e.g., high-level signals) overlap. That is, n=7 and m=6.

Exemplarily, with reference to FIGS. 10 and 11, it can be seen that the first group of sub-pixel rows 100A includes 4 rows of sub-pixels, where the periods during which the light-emitting control signal lines EM of the 1st row of sub-pixels, the 5th row of sub-pixels, and the 9th row of sub-pixels transmit disable signals (e.g., high-level signals) overlap. That is, n=4 and m=3.

In the embodiment of the present application, by setting n>m, after sequentially driving the rows of sub-pixels in the first group of sub-pixel rows 100A to enter the operating process, when driving the second group of sub-pixel rows 100B, the first row of sub-pixels in the second group of sub-pixel rows 100B can start to enter the reset phase t1 after its “previous” adjacent row of sub-pixels (e.g., belonging to the first group of sub-pixel rows 100A) and “subsequent” adjacent row of sub-pixels (e.g., belonging to the first group of sub-pixel rows 100A) sequentially enter the light-emitting phase t3, thereby being conducive to achieving that when a sub-pixel row in the second group of sub-pixel rows 100B is in the dark state, its “previous” adjacent row of sub-pixels (e.g., belonging to the first group of sub-pixel rows 100A) and “subsequent” adjacent row of sub-pixels (e.g., belonging to the first group of sub-pixel rows 100A) are both in the light-emitting state, thereby reducing the visual effect of the dark state sub-pixel row in the second group of sub-pixel rows 100B.

Moreover, when a sub-pixel row in the first group of sub-pixel rows 100A is in the dark state, its “previous” adjacent row of sub-pixels (e.g., belonging to the second group of sub-pixel rows 100B) and “subsequent” adjacent row of sub-pixels (e.g., belonging to the second group of sub-pixel rows 100B) of the sub-pixel row are both in the light-emitting state of the previous frame of picture, thereby reducing the visual effect of the dark sub-pixel row in the first group of sub-pixel rows 100A.

Optionally, n−m≥2.

The inventor of the present application has found through research that when sequentially driving the first group of sub-pixel rows 100A and the second group of sub-pixel rows 100B, the difference between n and m can affect the interval between the start time of the reset phase t1 of the sub-pixel rows in the second group of sub-pixel rows 100B and the start time of the light-emitting phase t3 of its adjacent sub-pixel rows (e.g., belonging to the first group of sub-pixel rows 100A). The larger the difference between n and m, the larger the interval.

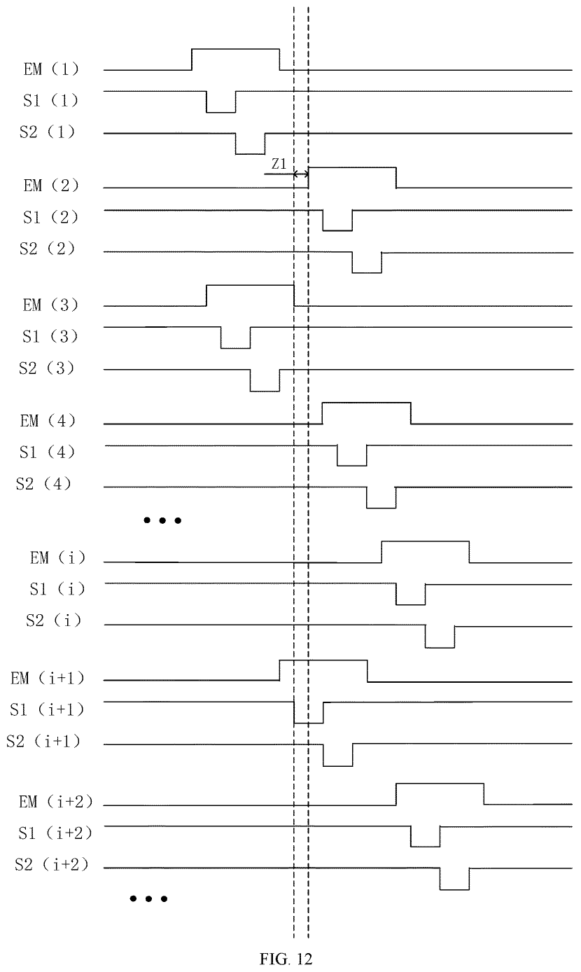

For example, as shown in FIG. 12, FIG. 12 is a driving timing diagram of another display panel according to an embodiment of the present application. Taking n=7 and m=5 as an example, the driving sequence of the display panel may be as shown in FIG. 9. In the first driving group 101, the first group of sub-pixel rows 100A includes odd-numbered rows of sub-pixels, and the second group of sub-pixel rows 100B includes even-numbered rows of sub-pixels. A 2nd row of sub-pixels is the first row of sub-pixels in the second group of sub-pixel rows 100B. In FIG. 12, an interval Z1 between the start time of the reset phase t1 of the 2nd row of sub-pixels and the start time of the light-emitting phase t3 of the 3rd row of sub-pixels is significantly larger than the interval between the start time of the reset phase t1 of the 2nd row of sub-pixels and the start time of the light-emitting phase t3 of the 3rd row of sub-pixels in FIG. 3. (In FIG. 3, the start time of the reset phase t1 of the 2nd row of sub-pixels overlaps the start time of the light-emitting phase t3 of the 3rd row of sub-pixels.)

In the embodiment of the present application, by setting n−m≥2, the interval between the dark state period of one sub-pixel row and the dark state periods of its adjacent sub-pixel rows can be increased, which is conducive to improving the reliability that the adjacent rows of the dark state sub-pixel row are in the light-emitting state, thereby being conducive to enhancing the visual effect of weakening the obviousness of the dark state sub-pixel row.

With continued reference to FIG. 1, in one embodiment of the present application, the display panel 01 includes a plurality of data signal lines DL. The data signal lines DL extend along the second direction Y, and the plurality of data signal lines DL are arranged along the first direction X.

In a same driving group 100, the data signal lines DL transmit data voltages sequentially to the first group of sub-pixel rows 100A and the second group of sub-pixel rows 100B.

Exemplarily, in a same driving group 100, the first group of sub-pixel rows 100A includes odd-numbered rows of sub-pixels, the second group of sub-pixel rows 100B includes even-numbered rows of sub-pixels, and the first group of sub-pixel rows 100A is driven before the second group of sub-pixel rows 100B. A same data signal line DL first transmits a data voltage to the odd-numbered rows of sub-pixels, and then transmits a data voltage to the even-numbered rows of sub-pixels.

In the embodiment of the present application, the data voltage transmitted by the data signal line DL can match the driving manner of the sub-pixel rows, ensuring that each sub-pixel receives a correct data voltage, thereby guaranteeing the display effect of the display panel 01.

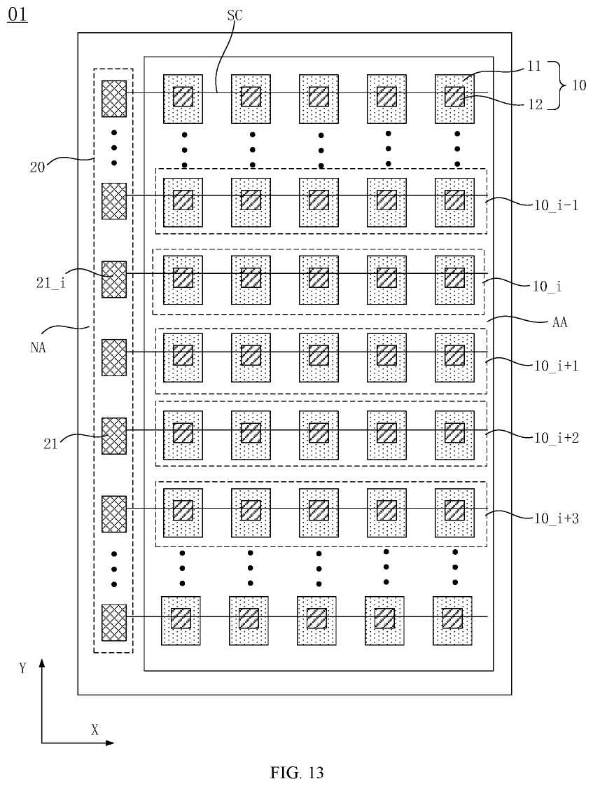

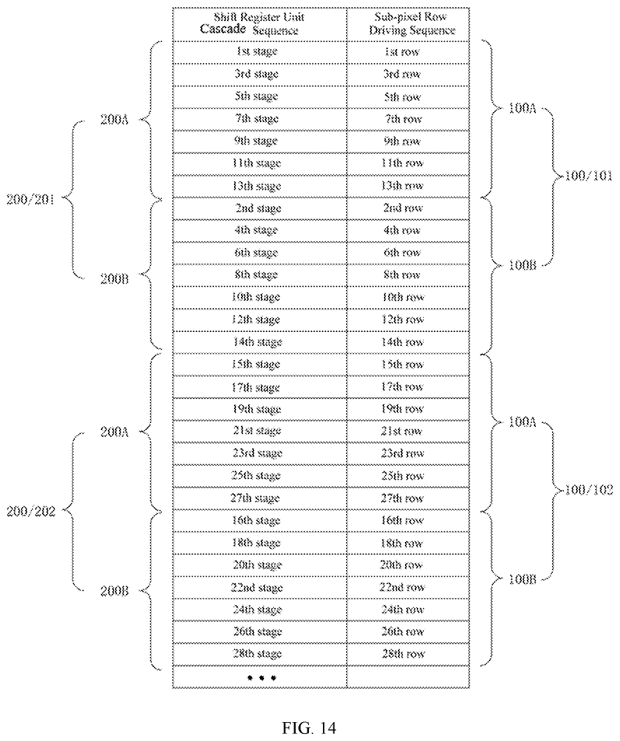

FIG. 13 is a schematic diagram of another display panel according to an embodiment of the present application, and FIG. 14 is a diagram of a cascading sequence of shift register units in FIG. 13.

In one embodiment of the present application, with reference to FIGS. 13 and 14, the display panel 01 includes a scan circuit 20. The scan circuit 20 includes a plurality of cascaded shift register units 21, and the plurality of cascaded shift register units 21 form at least one scan group 200. The scan group 200 is correspondingly electrically connected to the driving group 100.

Exemplarily, as shown in FIG. 13, the display panel 01 includes an active area AA and a non-active area NA surrounding the active area AA. The sub-pixels 10 are located in the active area AA, and the scan circuit 20 is located in the non-active area NA on a side of the active area AA. The scan circuit 20 is electrically connected to the sub-pixel rows through gate lines SC, and a same sub-pixel row is electrically connected to a same gate line SC.

In the embodiment of the present application, the gate line SC may refer to any one of the first scan line S1, the second scan line S2, and the light-emitting control signal line EM.

Herein, a same scan group 200 includes a first group of shift register units 200A and a second group of shift register units 200B. The first group of shift register units 200A is correspondingly electrically connected to the first group of sub-pixel rows 100A, and the second group of shift register units 200B is correspondingly electrically connected to the second group of sub-pixel rows 100B. The first group of shift register units 200A and the second group of shift register units 200B output scan signals sequentially.

In the embodiment of the present application, the scan group 200 can transmit scan signals to the corresponding driving group 100, thereby driving the sub-pixel rows to enter the operating process. In a same scan group 200, the first group of shift register units 200A is set to be correspondingly electrically connected to the first group of sub-pixel rows 100A, and the second group of shift register units 200B is set to be correspondingly electrically connected to the second group of sub-pixel rows 100B, such that the first group of shift register units 200A can drive the first group of sub-pixel rows 100A, and the second group of shift register units 200B can drive the second group of sub-pixel rows 100B. By enabling the first group of shift register units 200A and the second group of shift register units 200B to output scan signals sequentially, sequential driving of the first group of sub-pixel rows 100A and the second group of sub-pixel rows 100B in a same driving group 100 can be achieved.

Exemplarily, as shown in FIG. 14, the scan circuit 20 includes a plurality of scan groups 200. The number of scan groups 200 may be the same as the number of driving groups 100, and the plurality of scan groups 200 output scan signals sequentially.

In this way, the plurality of scan groups 200 can sequentially drive their corresponding driving groups 100, realizing sequential driving of the plurality of driving groups 100 in the display panel 01.

Further, in the correspondingly connected scan group 200 and driving group 100, the number of shift register unit groups in the scan group 200 may be the same as the number of sub-pixel row groups. The plurality of shift register unit groups can output scan signals sequentially, realizing sequential driving of each group of sub-pixel rows in the corresponding driving group 100.

For example, as shown in FIG. 14, the first scan group 201 is electrically connected to the first driving group 101. The first driving group 101 includes 2 sub-pixel row groups, and the first scan group 201 includes 2 shift register unit groups.

In one embodiment of the present application, as shown in FIG. 13, the plurality of shift register units 21 are arranged stage by stage along the second direction Y. The stage number of a shift register unit 21 is the same as the row number of the sub-pixel row to which it is electrically connected. For example, the shift register unit 21 electrically connected to the i-th row of sub-pixels 10_i is the i-th stage shift register unit 21_i.

With reference to FIG. 14, in a same scan group 200, the plurality of shift register units 21 in the first group of shift register units 200A and the plurality of shift register units 21 in the second group of shift register units 200B are arranged alternately along the second direction Y.

In the embodiment of the present application, arranging the shift register units 21 in different shift register unit groups alternately is conducive to making the stage number of the shift register unit 21 the same as the stage number of the sub-pixel row to which it is electrically connected, thereby being conducive to reducing the connection difficulty between the shift register unit 21 and the corresponding sub-pixel row.

Exemplarily, as shown in FIG. 14, the first scan group 201 is correspondingly electrically connected to the first driving group 101. In the first driving group 101, the first group of sub-pixel rows 100A includes odd-numbered rows of sub-pixels, and the second group of sub-pixel rows 100B includes even-numbered rows of sub-pixels.

In the first scan group 201, the shift register units 21 in the first group of shift register units 200A are odd-stage shift register units, and the shift register units 21 in the second group of shift register units 200B are even-stage shift register units.

In this way, the odd-stage shift register units can be correspondingly electrically connected to the odd-numbered rows of sub-pixels, and the even-stage shift register units can be correspondingly electrically connected to the even-numbered rows of sub-pixels, which is conducive to reducing the routing difficulty between the shift register unit 21 and the sub-pixel row to which it is electrically connected, and facilitates the first group of shift register units 200A to drive the first group of sub-pixel rows 100A composed of odd-numbered rows of sub-pixels, and the second group of shift register units 200B to drive the second group of sub-pixel rows 100B composed of even-numbered rows of sub-pixels.

With continued reference to FIG. 14, in one embodiment of the present application, both the first group of shift register units 200A and the second group of shift register units 200B include a plurality of shift register units 21. In a same group of shift register units, the plurality of shift register units 21 are cascaded sequentially.

That is to say, in the first group of shift register units 200A, respective shift register units 21 are cascaded sequentially; and in the second group of shift register units 200B, respective shift register units 21 are cascaded sequentially.

The embodiment of the present application is conducive to making the cascading sequence of the shift register units 21 the same as the driving sequence of the corresponding sub-pixel rows, realizing sequential driving of each group of sub-pixel rows.

Further, in a same scan group 200, the last shift register unit in the first group of shift register units 200A is cascaded with the first shift register unit in the second group of shift register units 200B.

For example, as shown in FIG. 14, the scan circuit 20 includes a plurality of scan groups 200, and the plurality of scan groups 200 include the first scan group 201. The first scan group 201 can be configured to drive the first driving group 101. The first scan group 201 includes 14 cascaded shift register units. The odd-stage shift register units form the first group of shift register units 200A, and the even-stage shift register units form the second group of shift register units 200B. The 13th-stage shift register unit is the last shift register unit in the first group of shift register units 200A, and the 2nd-stage shift register unit is the first shift register unit in the second group of shift register units 200B.

Herein, the odd-stage shift register units are cascaded sequentially, and the even-stage shift register units are cascaded sequentially. In addition, the last shift register unit (i.e., the 13th-stage shift register unit) in the first group of shift register units 200A is cascaded with the first shift register unit (i.e., the 2nd-stage shift register unit) in the second group of shift register units 200B.

In a same scan group 200, by cascading the last shift register unit in the first group of shift register units 200A with the first shift register unit in the second group of shift register units 200B, the first group of shift register units 200A can be cascaded with the second group of shift register units 200B, and after the shift register units 21 in the first group of shift register units 200A output scan signals sequentially, the last shift register unit in the first group of shift register units 200A can provide a trigger signal to the second group of shift register units 200B, so that the shift register units in the second group of shift register units 200B can output scan signals sequentially, without providing an additional trigger signal to the second group of shift register units 200B.

An embodiment of the present application further provides a driving method for a display panel 01, which is used to drive the display panel 01 according to the above embodiments. The structure of the display panel 01 may be as shown in FIGS. 1 and 13. The display panel 01 includes a plurality of sub-pixels 10, an i-th row of sub-pixels 10_i includes a plurality of sub-pixels 10 arranged along a first direction X, a plurality of rows of sub-pixels 10 are arranged along a second direction Y, and the second direction Y intersects the first direction X, where i is a positive integer.

Exemplarily, the first direction X is the row direction of the display panel 01, and the second direction Y is the column direction of the display panel 01.

The driving method includes: in one frame of picture of the display panel 01, during a period when an (i+1)-th row of sub-pixels 10_i+1 does not emit light, driving the i-th row of sub-pixels 10_i to emit light, and driving an (i+2)-th row of sub-pixels 10_i+2 to emit light.

For example, with reference to FIGS. 1, 2, 3, and 4, during the reset phase t1 and/or the data writing phase t2 of the (i+1)-th row of sub-pixels 10_i+1, the i-th row of sub-pixels 10_i is in the light-emitting phase t3, and the (i+2)-th row of sub-pixels 10_i+2 is in the light-emitting phase t3.

In the driving method according to the embodiment of the present application, during at least part of the period when the (i+1)-th row of sub-pixels 10_i+1 is in the dark state, the two rows of sub-pixels adjacent to it and located on opposite sides thereof can be driven to be in the light-emitting state, which is conducive to preventing multiple rows of sub-pixels in a same area from dimming simultaneously, thereby being conducive to reducing the obviousness of the dark state of the (i+1)-th row of sub-pixels 10_i+1, weakening the light-dark difference perceived by the human eye, and in turn being conducive to reducing the damage of the picture to the human eye, realizing the eye protection function of the display panel.

In one embodiment of the present application, the driving method further includes: in one frame of picture of the display panel 01, during the period when the (i+1)-th row of sub-pixels 10_i+1 does not emit light, driving at least two rows of sub-pixels adjacent to the (i+1)-th row of sub-pixels 10_i+1 and located on one side of the (i+1)-th row of sub-pixels 10_i+1 to emit light, and driving at least two rows of sub-pixels adjacent to the (i+1)-th row of sub-pixels 10_i+1 and located on the other side of the (i+1)-th row of sub-pixels 10_i+1 to emit light.

For example, with reference to FIGS. 1, 2, 3, and 8, during the reset phase t1 and/or the data writing phase t2 of the (i+1)-th row of sub-pixels 10_i+1, the i-th row of sub-pixels 10_i and the (i-1)-th row of sub-pixels 10_i−1 are in the light-emitting phase t3, and the (i+2)-th row of sub-pixels 10_i+2 and the (i+3)-th row of sub-pixels 10_i+3 are in the light-emitting phase t3.

In the embodiment of the present application, during at least part of the period when the (i+1)-th row of sub-pixels 10_i+1 is in the dark state, at least the “previous” two rows of sub-pixels and at least the “subsequent” two rows of sub-pixels relative to the (i+1)-th row of sub-pixels 10_i+1 are driven to be in the light-emitting state, which is conducive to further reducing the obviousness of the dark state of the (i+1)-th row of sub-pixels 10_i+1, thereby being conducive to further weakening the light-dark difference perceived by the human eye and improving the eye protection function of the display panel 01.

With reference to FIGS. 1 and 9, in one embodiment of the present application, the plurality of sub-pixel rows in the display panel 01 form at least one driving group 100, a same driving group 100 includes a first group of sub-pixel rows 100A and a second group of sub-pixel rows 100B, and multiple rows of sub-pixels in the first group of sub-pixel rows 100A and multiple rows of sub-pixels in the second group of sub-pixel rows 100B are arranged alternately along the second direction Y.

Exemplarily, the first group of sub-pixel rows 100A includes odd-numbered rows of sub-pixels, and the second group of sub-pixel rows 100B includes even-numbered rows of sub-pixels.

The driving method further includes: in one frame of picture of the display panel 01, driving the first group of sub-pixel rows 100A and the second group of sub-pixel rows 100B sequentially.

In the embodiment of the present application, by arranging the sub-pixel rows in the first group of sub-pixel rows 100A alternately with the sub-pixel rows in the second group of sub-pixel rows 100B, and driving the first group of sub-pixel rows 100A and the second group of sub-pixel rows 100B sequentially, interleaved driving of the plurality of sub-pixel rows in the same driving group 100 can be achieved, which is conducive to driving the i-th row of sub-pixels 10_i and the (i+2)-th row of sub-pixels 10_i+2 to enter the light-emitting phase t3 sequentially, and then driving the (i+1)-th row of sub-pixels 10_i+1 to enter the reset phase t1 or the data writing phase t2, thereby being conducive to achieving that when the (i+1)-th row of sub-pixels 10_i+1 is in the dark state, the two rows of sub-pixels adjacent to it and located on opposite sides thereof can be in the light-emitting state, which in turn is conducive to realizing the visual effect of reducing the dark state of the (i+1)-th row of sub-pixels 10_i+1.

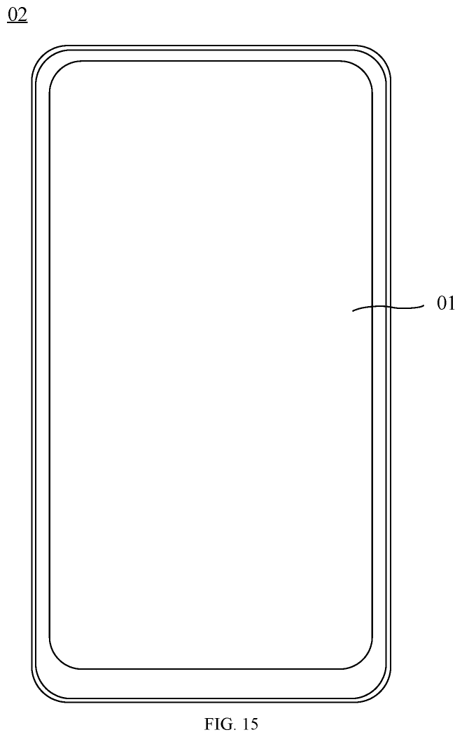

### FIG. 15 Is a Schematic Diagram of a Display Apparatus According to an Embodiment of the present application.

An embodiment of the present application provides a display apparatus 02, as shown in FIG. 15, the display apparatus 02 includes the display panel 01 according to the above-mentioned embodiments. Exemplarily, the display apparatus 02 may be an electronic device such as a mobile phone, a computer, a television, a vehicle-mounted display, and a wearable display, which is not specifically limited in the present application.

In the display apparatus 02, during the reset phase t1 and/or the data writing phase t2 of the (i+1)-th row of sub-pixels 10_i+1, the i-th row of sub-pixels 10_i is set to be in the light-emitting phase t3, and the (i+2)-th row of sub-pixels 10_i+2 is set to be in the light-emitting phase t3. Thus, during at least part of the period when the (i+1)-th row of sub-pixels 10_i+1 is in the dark state, the two rows of sub-pixels adjacent to it and located on opposite sides thereof can be in the light-emitting state, thereby being conducive to preventing multiple rows of sub-pixels in a same area from dimming simultaneously, reducing the obviousness of the dark state of the (i+1)-th row of sub-pixels 10_i+1, and weakening the light-dark difference perceived by the human eye, thereby reducing the damage of the picture to the human eye, realizing the eye protection function of the display panel.

The above are only preferred embodiments of the present application and are not intended to limit the present application. Any modifications, equivalent substitutions, improvements, etc., made within the spirit and principle of the present application shall be included in the protection scope of the present application.

What is claimed is:

1. A display panel, comprising a plurality of sub-pixels, wherein the sub-pixels comprise a pixel circuit and a light-emitting device that are electrically connected to each other, an i-th row of sub-pixels comprises a plurality of sub-pixels arranged along a first direction, a plurality of rows of sub-pixels are arranged along a second direction, and the second direction intersects the first direction, wherein i is a positive integer; and
wherein one operating period of the pixel circuit includes a reset phase, a data writing phase, and a light-emitting phase, and wherein during the reset phase and/or the data writing phase of an (i+1)-th row of sub-pixels, the i-th row of sub-pixels is in the light-emitting phase, and an (i+2)-th row of sub-pixels is in the light-emitting phase.

2. The display panel according to claim 1, wherein during the reset phase and/or the data writing phase of the (i+1)-th row of sub-pixels, at least two rows of sub-pixels adjacent to the (i+1)-th row of sub-pixels and located on one side of the (i+1)-th row of sub-pixels are in the light-emitting phase, and at least two rows of sub-pixels adjacent to the (i+1)-th row of sub-pixels and located on the other side of the (i+1)-th row of sub-pixels are in the light-emitting phase.

3. The display panel according to claim 1, wherein in the display panel, a plurality of sub-pixel rows form at least one driving group, a same driving group comprises a first group of sub-pixel rows and a second group of sub-pixel rows, and in one frame of picture of the display panel, the first group of sub-pixel rows and the second group of sub-pixel rows are driven sequentially; and
wherein a plurality of rows of sub-pixels in the first group of sub-pixel rows and a plurality of rows of sub-pixels in the second group of sub-pixel rows are alternately arranged in the second direction.

4. The display panel according to claim 3, wherein the display panel comprises a plurality of driving groups, and the plurality of driving groups are driven sequentially.

5. The display panel according to claim 3, wherein in the same driving group, a number of the sub-pixel rows comprised in the first group of sub-pixel rows is identical to a number of the sub-pixel rows comprised in the second group of sub-pixel rows;
wherein the plurality of rows of sub-pixels in the first group of sub-pixel rows are odd-numbered rows of sub-pixels, and the plurality of rows of sub-pixels in the second group of sub-pixel rows are even-numbered rows of sub-pixels.

6. The display panel according to claim 3, wherein in a same group of sub-pixel rows (either the first group or the second group), between two adjacent rows of sub-pixels in the second direction, there are at least two rows of sub-pixels not belonging to the group of sub-pixel rows.

7. The display panel according to claim 3, wherein the pixel circuit comprises:
a driving transistor;
a power voltage writing module having an input terminal electrically connected to a first power voltage signal line, an output terminal electrically connected to a first electrode of the driving transistor, and a control terminal electrically connected to a light-emitting control signal line;
a light-emitting control module having an input terminal electrically connected to a second electrode of the driving transistor, an output terminal electrically connected to a first electrode of the light-emitting device, and a control terminal electrically connected to the light-emitting control signal line;
in the light-emitting phase, the light-emitting control signal line transmits an enable signal, and both the power voltage writing module and the light-emitting control module are in a turned-on state; and
in the reset phase and the data writing phase, the light-emitting control signal line transmits a disable signal, and both the power voltage writing module and the light-emitting control module are in a turned-off state.

8. The display panel according to claim 7, wherein in the same driving group, the first group of sub-pixel rows and the second group of sub-pixel rows respectively comprise n rows of sub-pixels;
in one frame of picture of the display panel, in a same group of sub-pixel rows, periods during which the light-emitting control signal lines of m rows of sub-pixels transmit the disable signal overlap; and
n and m are positive integers, where n>m.

9. The display panel according to claim 8, wherein n−m≥2.

10. The display panel according to claim 3, wherein the display panel comprises a plurality of data signal lines, and the plurality of data signal lines extend along the second direction and are arranged along the first direction; and
in the same driving group, the data signal lines sequentially transmit data voltages to the first group of sub-pixel rows and the second group of sub-pixel rows.

11. The display panel according to claim 3, wherein the display panel comprises a scan circuit, the scan circuit comprises a plurality of cascaded shift register units, the plurality of cascaded shift register units form at least one scan group, and the scan group is electrically connected to a corresponding driving group; and
a same scan group includes a first group of shift register units and a second group of shift register units, the first group of shift register units are electrically connected to the first group of sub-pixel rows, the second group of shift register units are electrically connected to the second group of sub-pixel rows, and the first group of shift register units and the second group of shift register units sequentially output scan signals.

12. The display panel according to claim 11, wherein the scan circuit comprises a plurality of scan groups, and the plurality of scan groups sequentially output scan signals.

13. The display panel according to claim 11, wherein the plurality of cascaded shift register units are arranged stage by stage along the second direction, and in the same scan group, the plurality of cascaded shift register units in the first group of shift register units and those in the second group of shift register units are alternately arranged in the second direction.

14. The display panel according to claim 13, wherein the shift register units in the first group of shift register units are odd-stage shift register units, and the shift register units in the second group of shift register units are even-stage shift register units.

15. The display panel according to claim 11, wherein in the same scan group, a last shift register unit in the first group of shift register units is cascaded with a first shift register unit in the second group of shift register units.

16. The display panel according to claim 11, wherein the first group of shift register units and the second group of shift register units respectively comprise a plurality of shift register units, and in a same group of shift register units, the plurality of shift register units are sequentially cascaded.

17. The display panel according to claim 7, wherein the pixel circuit further comprises:
a first reset module having an input terminal electrically connected to a first reset voltage signal line, an output terminal electrically connected to a gate of the driving transistor, and a control terminal electrically connected to a first scan line;
a data writing module having an input terminal electrically connected to a data signal line, an output terminal electrically connected to the first electrode of the driving transistor, and a control terminal electrically connected to a second scan line;
a threshold capturing module having an input terminal electrically connected to the second electrode of the driving transistor, an output terminal electrically connected to the gate of the driving transistor, and a control terminal electrically connected to the second scan line;
and a second reset module having an input terminal electrically connected to a second reset voltage signal line, an output terminal electrically connected to the first electrode of the light-emitting device, and a control terminal electrically connected to the second scan line; and in one operating period of the pixel circuit, the data writing phase is subsequent to the reset phase;
wherein the first reset module is turned on in the reset phase, and the second reset module, the data writing module, and the threshold capturing module are turned on in the data writing phase.

18. A driving method of a display panel, wherein the display panel comprises a plurality of sub-pixels, an i-th row of sub-pixels comprises a plurality of sub-pixels arranged along a first direction, a plurality of rows of sub-pixels are arranged along a second direction, the second direction intersects the first direction, and i is a positive integer, wherein the method comprises:
in one frame of picture of the display panel, during a period when an (i+1)-th row of sub-pixels does not emit light, driving the i-th row of sub-pixels to emit light and driving an (i+2)-th row of sub-pixels to emit light.

19. The driving method according to claim 18, further comprising:
in one frame of picture of the display panel, during the period when the (i+1)-th row of sub-pixels does not emit light, driving at least two rows of sub-pixels adjacent to the (i+1)-th row of sub-pixels and located on one side of the (i+1)-th row of sub-pixels to emit light, and driving at least two rows of sub-pixels adjacent to the (i+1)-th row of sub-pixels and located on the other side of the (i+1)-th row of sub-pixels to emit light.

20. The driving method according to claim 18, wherein in the display panel, a plurality of sub-pixel rows form at least one driving group, a same driving group comprises a first group of sub-pixel rows and a second group of sub-pixel rows, and a plurality of rows of sub-pixels in the first group of sub-pixel rows and a plurality of rows of sub-pixels in the second group of sub-pixel rows are alternately arranged in the second direction; and
the method further includes:
driving the first group of sub-pixel rows and the second group of sub-pixel rows sequentially in one frame of picture of the display panel.
